(19) United States
(12) Patent Application Publication
(10) Pub. No.: US 2022/0264799 A1
(43) Pub. Date: Aug. 25, 2022

(54) AGRICULTURAL MACHINE AND METHOD FOR HARVESTING FIBRE CROPS

(71) Applicant: HEMP INVEST B.V., Halle (BE)

(72) Inventor: Veasna CHAN, Halle (BE)

(21) Appl. No.: 17/623,012

(22) PCT Filed: Jun. 25, 2020
(86) PCT No.: PCT/IB2020/056027

§ 371 Date: Dec. 27, 2021

(30) Foreign Application Priority Data
Jun. 25, 2019 (BE) BE 2019/5411

(51) Int. Cl. A01D 43/08; A01D 45/06; A01D 61/00; A01D 61/02

(52) U.S. Cl. CPC A01D 43/08; A01D 45/065; A01D 61/002; A01D 61/02

(57) ABSTRACT

Agricultural machine and method for harvesting a crop with upright stalks (29) on a soil, wherein means of transport are provided to convey the stalks (29) harvested upright to a feed-through channel (6), wherein the means of transport are provided on the front (1) of the machine and comprise at least a conveyor belt (7, 14) extending partly at the front (1) of the agricultural machine and which is designed to be driven in a direction of rotation (8) thereof in order to transport cut stalks (29) substantially upright to said feed-through channel (6). A cutter (12) is provided extending in said feed-through channel (6) to cut the stalks (29) while they are being moved upright through the feed-through channel (6).

The invention generally concerns a machine and method for harvesting a crop with long upright stalks, and it is particularly interesting for harvesting hemp which has stalks usually between 2 and 4 metres long when it is harvested. The fibres extracted from the hemp plant are used, for example, to make rope, textiles, building materials, etc.

When harvesting hemp, an elongated cutter bar having a cutting width is moved horizontally in a harvesting direction across a field, with the longitudinal direction of the cutter bar extending almost transversely to the harvesting direction. At the front of the cutter bar, the stalks are removed from the ground over said cutting width and the stalks are then moved upright to a feed-through channel which extends at least partly transversally to the longitudinal direction of the cutter bar and within the cutting width of the latter. The stalks are cut into at least two pieces while they are moved upright through the feed-through channel.

Usually, after harvesting, the stalks are ejected from the machine at the rear of the cutter bar.

Documents WO 03/105567 A2 and U.S. Pat. No. 3,791,114 describe harvesting machines for sugar cane, which also has long stalks. However, these machines are designed for harvesting crops planted in rows with a nearly constant distance between adjacent rows. Such sugar cane harvesters are not suitable for harvesting crops which do not extend in parallel rows over a field, as is the case with, for example, hemp. Indeed, hemp plants are normally sown in such a way that the hemp stalks are distributed randomly over a field at a relatively high density. The hemp stalks thus do not extend in parallel rows.

A machine for harvesting hemp stalks is described in document EP 1 623 617 A1. This machine allows hemp stalks to be harvested on adjacent strips of a field and to that end has a pivoting arm with cutting means to cut the hemp stalks above the ground. This pivoting arm is mounted on a drive device, such as a tractor, to move the agricultural machine in a harvesting direction across the field. For the operation of the agricultural machine described in this document EP 1 623 617 A1, it is necessary for the drive device to move over a crop-free strip next to the crop being harvested. The harvested stalks are thrown on the ground behind the tractor. As a result, these newly harvested stalks are not thrown on the ground in the zone behind the cutting means, as the drive device must move over this zone when harvesting the next row of hemp stalks.

Such a machine thus has the disadvantage that its drive device has to move over a crop-free strip next to the crop to be harvested. Consequently, when harvesting the crop, it is not possible to move the machine back and forth across the field, thereby harvesting successive adjacent strips of the crop.

The invention aims to remedy this by proposing an agricultural machine in which the harvesting of the crop can be done in a simple manner, without having to provide a crop-free strip and without requiring the crop to extend in parallel rows over a field, with the cut stalks being laid down behind the machine, preferably transversely to the harvesting direction. More specifically, the invention aims to propose a compact agricultural machine of relatively limited dimensions that can easily be used for harvesting crops such as hemp on fields with a relatively small or irregular surface, wherein these crops are present in the field with a relatively high density.

To this end, said stalks are carried along through the feed-through channel by superimposed conveyor belts that extend substantially in line with each other. There is a free space between these superimposed, successive conveyor belts, and the stalks are cut into at least two pieces at the height of this free space by means of a cutter while the stalks are being moved upright through the feed-through channel. After cutting the stalks into pieces, each piece of the stalks is moved further along through the feed-through channel by at least one of the above-mentioned conveyor belts to an ejection opening where said pieces are ejected behind the cutter bar within the cutting width of the cutter bar.

Practically, said stalks are being clamped as they move through the feed-through channel between opposite conveyors moving in the same direction, which laterally delimit the feed-through channel. These conveyor belts thus carry said stalks along through the feed-through channel.

Advantageously, said stalk pieces are ejected in a row on the ground behind the cutter bar, in such a way that these pieces extend practically at right angles to the harvesting direction in said row.

According to a preferred embodiment of the method according to the invention, said stalks are cut near the ground with the aid of the cutter bar in order to remove them from the ground.

According to an interesting embodiment of the method, the top of the stalks of said crop has a seed-bearing end and, when moving the stalks through the feed-through channel, this seed-bearing end is separated from the stalks.

The invention also concerns an agricultural machine for harvesting a crop with stalks standing upright on a soil. This machine can be moved across the soil in a harvesting direction because it is equipped with an integrated drive device or because it has means for mounting it on a vehicle such as, for example, a combine harvester or tractor. The agricultural machine is hereby driven by the vehicle via a coupling provided to that end.

Furthermore, the machine has a front that has harvesting means to remove the upright stalks from the soil. This harvesting means extends across a cutting width of the machine. In particular, the harvesting means should preferably extend over almost the entire front of the agricultural machine between opposite lateral ends thereof.

Means of transport are provided to transport the stalks removed from the soil practically upright from the harvesting means to a feed-through channel with an entry opening on said front and an exit forming an ejection opening at the rear of the machine. The means of transport on said front are provided over at least a part of said cutting width and include at least a first conveyor belt extending partly at the front of the agricultural machine and which is designed to be driven in a direction of rotation from one of said lateral ends to the entry of the feed-through channel in order to transport cut stalks substantially upright to this feed-through channel.

This machine is characterised in that at least one cutter is provided which extends into said feed-through channel and which allows the stalks to be cut into at least two pieces while they are being moved upright through the feed-through channel. These means of transport include, at least downstream of said cutter, a conveyor belt above the level of the cutter and a conveyor belt extending below this level.

According to an interesting embodiment of the machine according to the invention, opposite sides of said feed-through channel are each at least partially formed by at least one conveyor belt, wherein these conveyor belts can be moved in the same direction and allow said stalks or said pieces of them to be clamped as they move through the feed-through channel.

Advantageously, the cutter extends through a free space between conveyor belts located on the same side of the transport channel. The cutter may possibly extend in said feed-through channel beyond its opposite sides.

According to a preferred embodiment of the agricultural machine according to the invention, the surfaces of said conveyor belts on one and the same side of the feed-through channel extend in line and above each other.

According to a particularly interesting embodiment of the agricultural machine according to the invention, said means of transport contain at least one conveyor belt extending both on the front of the agricultural machine and on one side of said feed-through channel. Consequently, this conveyor belt forms a moving wall of the feed-through channel.

Other particularities and advantages of the invention will become clear from the following description of some specific embodiments of the agricultural machine and the method according to the invention. This description is given as an example only and does not limit the scope of the claimed protection in any way; the reference numbers used hereinafter refer to the appended figures.

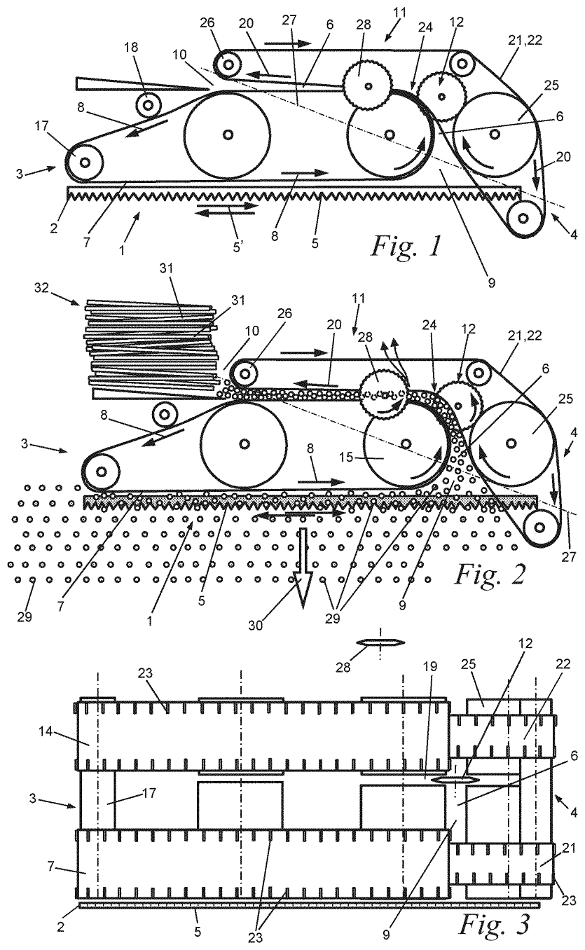

FIG. 1 is a schematic top view of the agricultural machine according to an interesting embodiment of the invention that illustrates its working principle.

FIG. 2 is view similar to that in FIG. 1 when the agricultural machine is being moved over a field when harvesting a crop.

FIG. 3 is a schematic principle drawing of a front view of the agricultural machine from FIG. 1.

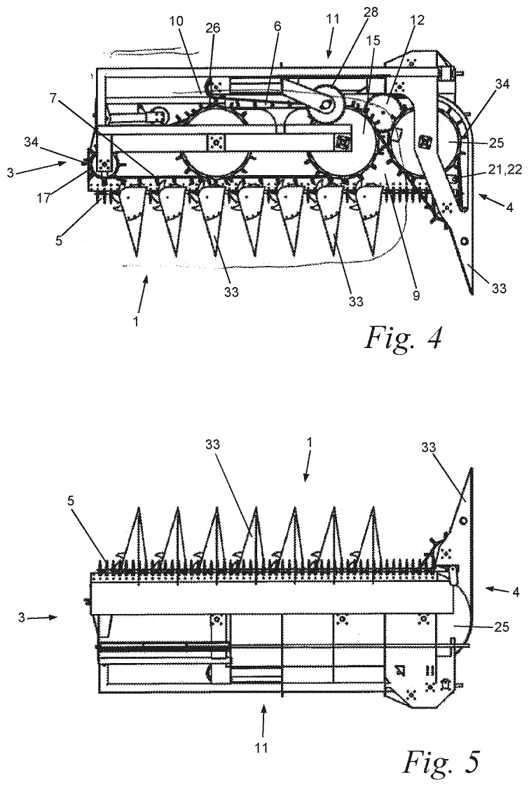

FIG. 4 is a schematic drawing of a top view, corresponding to that from FIG. 1, of an agricultural machine according to the invention.

FIG. 5 is a schematic bottom view of the agricultural machine from FIG. 4.

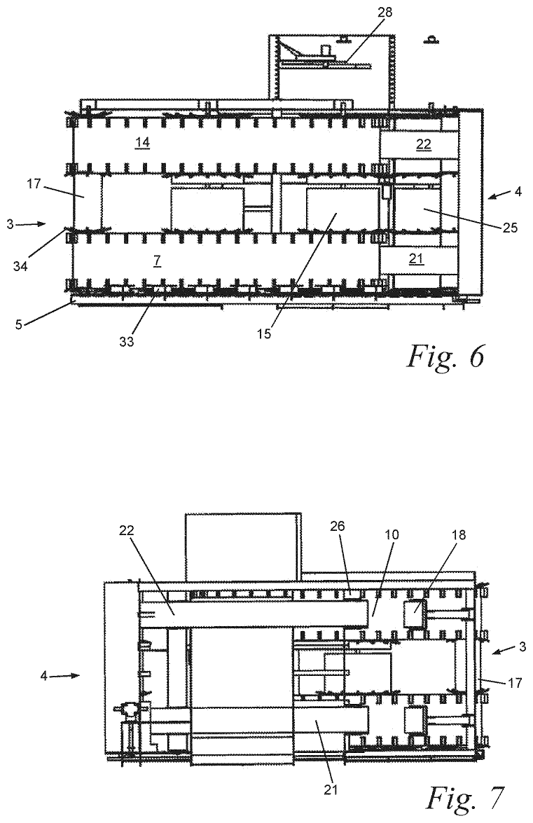

FIG. 6 is a schematic front view of the agricultural machine from FIGS. 4 and 5.

FIG. 7 is a schematic rear view of the agricultural machine from FIGS. 4 to 6.

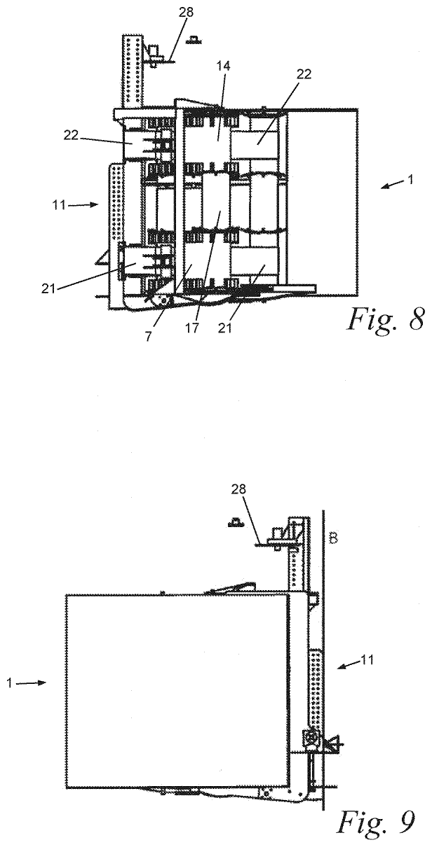

FIG. 8 is a schematic left-hand side view of the agricultural machine from FIGS. 4 to 7.

FIG. 9 is a schematic right-hand side view of the agricultural machine from FIGS. 4 to 8.

In the different figures, the same reference numbers refer to the same or analogous elements.

The invention generally concerns an agricultural machine for harvesting stalks of a crop from which long fibres are extracted. Thus, the machine is particularly suitable for harvesting relatively long stalks of hemp whose fibres are used in, for example, the textile industry, the construction industry, for making rope, etc. Hemp stalks can have a length of 2 to 4 metres when harvested.

For many applications of hemp fibres, it is important that the fibres extracted from the hemp plants are as long as possible. Thus, the invention seeks to propose a method and a machine which make sure that stalks of a relatively long length are harvested, while keeping the dimensions of the agricultural machine used for harvesting such stalks relatively limited. This also allows the machine to be easily applied on small fields for which the use of, for example, large combine harvesters is not appropriate.

The agricultural machine according to the invention may itself be equipped with drive devices to move over a field in a harvesting direction in order to harvest the crop. It is, of course, also possible for the agricultural machine to be mounted on another drive device, such as a combine harvester or a tractor. In such cases, however, it is important that the drive device, in particular a combine harvester or tractor, when moving the agricultural machine over a field, is situated behind the latter and, preferably, has a smaller width than that of the agricultural machine.

Furthermore, the agricultural machine according to the invention may be collapsible. This implies, for example, that the machine has a vertical pivot axis midway between the lateral ends. In this way, this pivot axis divides the agricultural machine into approximately two equally long pieces which can be moved towards each other around the pivot axis. This allows the machine to be folded so as to form an even more compact unit so that it can be easily transported on public roads while being mounted on a tractor or combine harvester.

FIGS. 1 to 3 schematically represent an agricultural machine according to the invention to illustrate its working principle.

This machine has a frame to which several pieces are attached. For the sake of clarity, this frame is not shown in the figures. The machine can be moved with the frame over a soil, such as a field, to harvest long upright stalks of a crop, such as hemp.

A front 1 of this agricultural machine is equipped with harvesting means 2 to remove the upright stalks from the soil of a field. This harvesting means 2 extends over a cutting width of the machine between opposite lateral ends 3 and 4 of the machine. As a result, the harvesting means 2 extends over almost the entire front end 1 of the agricultural machine. This harvesting means 2 should preferably be located at a small distance above the soil of a field when the agricultural machine is operating while harvesting a crop on the field.

The harvesting means 2 may, for example, be equipped to pull crops out of the soil together with their root system, but should preferably include cutting means that allow the upright stalks of the crop to be harvested to be cut off above ground near the soil, thus removing them from their root system. Such cutting means are known to the professional, and are preferably formed by a cutter bar 5, as is the case in the embodiment of the invention shown in the figures. Such a cutter bar 5 comprises, for example, two knives that can be moved in relation to each other according to a back and forth motion in relation to each other, as indicated by the arrows 5′ in FIG. 1. In general, by a cutter bar 5 is meant an elongated construction equipped with cutting means such as, for example, blades which can be moved in relation to one another, circular cutters placed next to each other and rotating around their axis, etc. that allow said upright stalks 29 to be cut off near the ground when the cutter bar 5 is moved across this ground. Often, the cutting means of the cutter bar 5 comprise an upper and a lower blade, each formed by a row of triangular adjacent blades, wherein the upper blade can be moved back and forth in relation to the lower blade, allowing a cutting movement so as to cut the crop.

Furthermore, the agricultural machine is equipped with means of transport to transport the stalks, after they have been removed from the ground, upright to a feed-through channel 6. These means of transport extend over at least a part of the front 1 of the machine, i.e. over at least a part of its cutting width. These means of transport are formed at least by a first conveyor belt 7 which extends partly at the front 1 of the agricultural machine. This conveyor belt 7 is designed to be driven according to a direction of rotation thereof from one of said lateral ends 3 to the entry 9 of said feed-through channel 6. This direction of rotation is indicated by an arrow 8.

Thus the conveyor belt 7 ensures that stalks that have been removed from the ground with the aid of the harvesting means 2, are moved to the feed-through channel 6. To this end, this conveyor belt 7, in the machine as shown in the figures, extends at least at the front end 1 thereof between said lateral end 3 and the entry of the feed-through channel 6, with the conveyor belt 7 moving almost parallel to the longitudinal direction of harvesting means 2, in particular of the cutter bar 5, from the end 3 to the feed-through channel 6, as indicated by arrow 8. Thus, a piece of the conveyor belt 7 extends parallel to the cutter bar 5 for part of its length. The conveyor belt 7 thus ensures that, during the movement of the harvester across the field, cut stalks are transported almost upright to the feed-through channel 6. Said cutting means of the cutter bar 5 should preferably extend at least partly in front of the means of transport at the front 1 of the machine such that the crops are removed from the ground, for example cut above the ground, and are then immediately transported in an upright position to the entry 9 of the feed-through channel 6 by the means of transport while the agricultural machine is being moved over the ground in the harvesting direction 30.

The feed-through channel 6 thus has an entry 9 which opens on the front 1 of the agricultural machine and an exit 10 which forms an ejection opening at the rear 11 of the machine. The harvested stalks leave the machine through this ejection opening.

The machine further has at least one cutter 12 designed to cut harvested stalks into at least two pieces 31. This cutter 12 extends into the feed-through channel 6 and cuts the harvested stalks at right angles to their longitudinal direction while they are moved upright through the feed-through channel 6. As shown in the figures, the cutter 12 is preferably formed by a circular saw blade driven around a central axis 13 thereof. This saw blade extends, for example, almost horizontally, but it may also have an inclination in relation to a horizontal plane.

Downstream of the cutter 12 in said feed-through channel, the means of transport are formed at least by said conveyor belt 7 which extends below the level of the cutter 12, and a conveyor belt 14 which extends above this level. These conveyor belts 7 and 14 thus limit one side of the feed-through channel 6 and form a moving wall thereof.

In the preferred embodiment of the invention as shown in the figures, the conveyor belts 7 and 14 extend one above the other and each form a closed loop. Each conveyor belt 7 and 14 herein runs from a lateral end 3 of the machine along the front 1 of the machine to the entry 9 of the feed-through channel 6. In the feed-through channel 6, the conveyor belts 7 and 14 run in a continuous manner and thus form one side of this feed-through channel 6. At the exit 10 of the feed-through channel 6, the conveyor belts 7 and 14 run further along said far end 3 to the front 1.

In the feed-through channel 6, the surfaces of the conveyor belts 7 and 14 consequently extend on the same side thereof, in line and above each other. The conveyor belts 7 and 14 are preferably formed by relatively wide flexible belts, each forming a loop and being guided over upright, almost parallel cylinders 15, 16, 17 and 18. Preferably, at least one of these cylinders is driven around its axis in order to move the conveyor belts 7 and 14 in their directions of rotation 8.

Furthermore, it is advantageously ensured that the cutter 12 extends through a free space 19 formed by a gap present in the cylinder 18 and between the conveyor belts 7 and 14 extending on the same side of the feed-through channel 6.

On the side of the feed-through channel 6 opposite to said conveyor belts 7 and 14, there is also a free space through which the cutter 12 protrudes.

In this way, the cutter 12 extends in said feed-through channel 6 beyond each of its opposite sides. This ensures that the stalks 29, which are moved through the feed-through channel 6, are cut in two pieces 31 by the cutter 12, and this prevents stalks being moved from the entry 9 to the exit 10 without being cut.

According to the preferred embodiment of the invention represented in the figures, the opposite sides of the feed-through channel 6 are each at least partly formed by a conveyor belt. In order to allow the stalks 29 to be moved through the feed-through channel 6, they are clamped between the opposite sides of the feed-through channel 6. To this end, the conveyor belts forming these sides can be moved in the same direction as indicated by arrows 8 and 20.

Thus, in the embodiment of the agricultural machine according to the invention shown in the figures, the feed-through channel 6 is defined on one side by the above-mentioned conveyor belts 7 and 14 which run along the lateral end 3 via the entry 9 to the feed-through channel 6. The opposite side of the feed-through channel 6 is formed by the surface of two conveyor belts 21 and 22 extending on top of each other which run from the front end 1 of the machine at the lateral end 4, via the entry 9, along the feed-through channel 6 and thus form one side of this feed-through channel 6. The surfaces of these conveyor belts 21 and 22 are also, preferably, in line with each other and extend almost vertically.

The means of transport, in particular said conveyor belts, may be equipped with carriers 23 which ensure that the harvested stalks 29 are carried along and moved by these means of transport. Such carriers 23, in the embodiment of the machine shown in FIG. 3, are provided on the surface of both conveyor belts 7 and 14 extending to the left lateral end 3 of the machine, and of the conveyor belts 20 and 21 extending to the opposite right lateral end 4 of the machine.

These carriers 23 can take all kinds of shapes that ensure that the harvested stalks follow the movement of the conveyor belts. In the present example, they are formed by studs protruding from the surface of the conveyor belts.

In the embodiment of the agricultural machine shown in FIGS. 4 to 9, carriers 23 or studs are only provided on the conveyor belts 7 and 14 on one side of the feed-through channel 6. The conveyor belts 21 and 22 which form the opposite side of the feed-through channel 6 do not have carriers 23. However, these conveyor belts 21 and 22 have a vertical height that allows them to extend between the studs of the corresponding opposite conveyor belts 7 and 14. On the latter conveyor belts 7 and 14, the carriers 23 are located near their respective upper and lower edges. This ensures that even when a limited amount of stalks having a thickness less than the height of the carriers 23 is moved through the feed-through channel, these stalks will still be clamped between the opposite conveyor belts such that they are carried along by the moving conveyor belts.

In this connection, the feed-through channel 6 has a bend 24 at the level of the cylinder 15 connecting to the entry 9 of the feed-through channel 6. The conveyor belts 20 and 21 on the side of the feed-through channel 6 opposite this cylinder 15 run over two successive, preferably parallel and almost vertical cylinders 25 and 26 here. To ensure that there is always sufficient pressure force between the conveyor belts of the opposite sides of the feed-through channel 6 and in particular at the level of said bend 24, it is preferably made sure that a common tangent plane 27 on the cylinders 25 and 26 on the side of the feed-through channel 6 cuts the cylinder 15 or the opposite conveyor belts 7 and 14.

This ensures that the conveyor belts 21 and 22 of one side of the feed-through channel 6 are pressed against the conveyor belts 7 and 14 of the opposite side of the feed-through channel 6. It is thereby made sure that, during the operation of the machine, there is always a tensile stress in the conveyor belts 21 and 22. This tensile stress can be obtained, for example, by manufacturing the conveyor belts from an elastic material. In addition, or alternatively, one of the cylinders over which these conveyor belts 21 and 22 run may also be resiliently mounted so as to ensure that a tensile stress is maintained in the conveyor belts 21 and 22.

Thus, when there are no stalks or pieces of stalks in the feed-through channel 6, the conveyor belts 21 and 22 in said bend 24 will be stretched up against the opposite conveyor belts 7 and 14, as shown in FIG. 1. When harvesting stalks, they are fed through the feed-through channel 6 by the conveyor belts 7, 14, 21 and 22, clamping them between the opposite conveyor belts 7 and 21, and 14 and 22, respectively. Here, the distance between the opposite sides of the feed-through channel 6 automatically adjusts to the amount of stalks, and their thickness, which are being moved through the feed-through channel 6, while sufficient pressure is being applied on the stalks so as to clamp them between the opposite conveyor belts.

Said cutter 12 is thus preferably provided at the level of this bend 24 in the feed-through channel 6 since the stalks 29 are being held there with the greatest force and are carried along between the conveyor belts.

Normally a cutting element 28 is provided at the top of the feed-through channel 6 to separate the seed-bearing end of the harvested crop from its stalks. This cutting element 28 is formed, for example, by a circular saw blade which extends almost horizontally and is driven around a central axis thereof. Adjacent to the cutting element 28, a discharge channel, not shown in the figures, is preferably provided for discharging the seed from the seed-bearing ends of the stalks to, for example, a threshing system or a rear collecting tray.

Said exit 10 of the feed-through channel 6 forms an ejection opening for the pieces 31 of the stalks 29 that have been harvested. This exit 10 is preferably situated at a distance from each of the lateral ends 3 and 4 of the agricultural machine which is at least equal to the vertical distance between the cutting means and said cutter 12. In other words, this means that the distance between the lateral ends 3 or 4 of the agricultural machine and the exit 10 of the feed-through channel is greater than or equal to the length of the pieces 31 formed by cutting the stalks 29 with the cutter 12. Thus, it is ensured that these pieces, as they leave the feed-through channel 6, are ejected behind the machine and not beyond either of its ends 3 or 4.

FIG. 2 schematically shows the harvesting of a crop with stalks 29 standing upright on the ground, such as hemp, using the agricultural machine according to the invention. This involves moving the machine with the elongated cutter bar 5 horizontally in a harvesting direction across the soil of the field on which the crop is situated. The harvesting direction is indicated in FIG. 2 by an arrow 30. The longitudinal direction of the mowing bar 5 extends almost perpendicular to the harvesting direction 30 here.

When moving the agricultural machine, the stalks 29 are removed from the soil at the front of the cutter bar 5 over the entire cutting width of the cutter bar 5. More specifically, the stalks 5 are cut off near the soil by means of the cutter bar 5.

The stalks 29 are then moved upright to the feed-through channel 6 which extends at least partly transversely to the longitudinal direction of the cutter bar 5 and opens within the cutting width of the latter at the front 1 of the machine. Due to the movement of the agricultural machine in the harvesting direction 30, the cut stalks 29 are pressed against the transport means, in particular against said conveyor belts 7 and 14. As a result of the movement of these conveyor belts according to their direction of rotation as indicated by arrow 8, the cut stalks are gripped by said carriers 23 and fed upright to the entry 9 of the feed-through channel 6. Next, the stalks 29 are clamped between the opposite sides of the feed-through channel 6 and moved further upright along said cutter 12 where the stalks 29 are cut into two pieces 31.

The pieces 31 thus obtained are moved further through the feed-through channel 6 with the upper pieces being moved further by the opposite conveyor belts 14 and 22, while the lower pieces of the stalks are being clamped by the lower opposite conveyor belts 7 and 21. In this way, the cut pieces 31 of the stalks 29 are fed to the exit of the feed-through channel 6 where the pieces are ejected at the rear 11 of the machine between said lateral ends 3 and 4.

These pieces of the stalks 29 are thus ejected in one or several rows on the ground behind the cutter bar 5. It is thereby ensured that these pieces 31 of the stalks 29 extend in the rows practically at right angles to the harvesting direction 30. In the embodiment of the invention as shown in FIG. 2, the pieces 31 of the stalks 29 are ejected on the soil of the field in a single row 32 behind the agricultural machine.

Furthermore, when moving the stalks 29 through the feed-through channel 6, the top of the crop that forms a seed-bearing end is removed from the stalks using the aforementioned cutting element 28. As indicated by arrows, this seed is tossed backwards and possibly guided further to a thresher or a collecting hopper.

FIGS. 4 to 9 show a practical embodiment of an agricultural machine according to the invention. At the front 1 of the machine it contains pointed crop guides 33 which ensure that, while the machine is moved over a field when harvesting a crop, the stalks of the crop are guided to the cutter bar 5.

In addition, cylinders 15, 16, 17 and 25 have, among others, carriers 34 extending in the space between two superimposed conveyor belts and next to the latter, wherein these carriers 34 allow to grasp and carry along harvested stalks 29 to the feed-through channel 6. However, such carriers 34 are not necessary for the proper functioning of the machine and may be lacking.

Of course, the invention is not restricted to the above-described method and the embodiments of the agricultural machine represented in the accompanying figures. Thus, the different features of these embodiments can be combined.

The harvested stalks can also be laid down on a field parallel to the harvesting direction when they are ejected.

The cutter 12 or the cutting element 28 need not necessarily consist of a circular saw blade, but may, for example, also be formed by a blade that can be moved back and forth or any other device for cutting the stalks.

In certain cases, it is not necessary to cut the harvested stalks 31 into two or more pieces 31 and these stalks 29 may, for example, be ejected as a whole behind the machine. In this case, the stalks 29 are also ejected in such a way that they extend in rows almost perpendicular to the harvesting direction 30. To allow this, cutter 12 is for example removed from the machine, or an agricultural machine is adapted in such a way that this cutter 12 is absent or possibly removable from the feed-through channel 6.

When, in the above description, reference is made to upright stalks, this also includes stalks which are at a slight angle to the vertical. For example, an angle smaller than 30°.

More specifically, when harvesting a crop, it is also possible for the agricultural machine to be slightly inclined, so that the stalks also move slightly inclined to the feed-through channel and through the latter. The inclination with respect to the vertical may, for example, be between 1° and 30°.

1. Agricultural machine for harvesting a crop with upright stalks on a soil, wherein the machine is movable over this soil in a harvesting direction and has a front with harvesting means to remove the upright stalks from the soil, wherein the harvesting means extends over a cutting width of the machine and wherein means of transport are provided to convey the stalks removed from the bottom substantially upright to a feed-through channel with an entry opening onto said front and an exit forming an ejection opening at a rear side of the machine, wherein said harvesting means comprise a cutter bar extending over substantially the full front of the agricultural machine between opposite lateral ends of the machine, wherein said means of transport are provided on said front over at least a part of said cutting width and comprise at least a first conveyor belt extending partly at the front of the agricultural machine and which is designed to be driven in a direction of rotation thereof from one of said ends to the entry of said feed-through channel, wherein this conveyor belt extends at said front from this end to said entry, in order to transport cut stalks substantially upright to said feed-through channel, characterised in that at least one cutter is provided extending in said feed-through channel and allowing the stalks be cut into at least two pieces while they are being moved upright through the feed-through channel wherein said means of transport contain, at least downstream of said cutter, a second conveyor belt which extends above the level of the cutter whereas said first conveyor belt extends below this level.

2. Agricultural machine according to claim 1, wherein opposite sides of said feed-through channel are each formed at least partly by a conveyor belt, wherein these conveyor belts can be moved in the same direction and allow to clamp said stalks or said pieces thereof as they move through the feed-through channel.

3. Agricultural machine according to claim 1, wherein said cutter extends through a free space between said conveyor belts extending on the same side of the feed-through channel.

4. Agricultural machine according to claim 1, wherein said means of transport comprise at least one conveyor belt extending both on the front of the agricultural machine and on one side of said feed-through channel.

5. Agricultural machine according to claim 1, wherein said cutter extends in said feed-through channel beyond the opposite sides thereof.

6. Agricultural machine according to claim 1, wherein the surfaces of said conveyor belts on one and the same side of said feed-through channel extend in line and above one another.

7. Agricultural machine according to claim 1, wherein said means of transport, in particular said conveyor belts, are equipped with carriers which ensure that said stalks are moved by the means of transport.

8. Agricultural machine according to claim 7, wherein said carriers extend on the opposite sides of the feed-through channel at different levels.

9. Agricultural machine according to claim 7, wherein said carriers are only provided on the conveyor belts of one side of the feed-through channel, wherein the conveyor belts of the opposite side thereof extend between these carriers.

10. Agricultural machine according to claim 1, wherein said cutter bar comprises cutting means which allow to cut said upright stalks above ground near said soil, wherein the cutting means extend over said cutting width of the machine.

11. Agricultural machine according to claim 10, wherein said cutting means extend at least partly in front of said means of transport at said front.

12. Agricultural machine according to claim 1, wherein said exit of the feed-through channel is situated at a distance from each of said ends of the agricultural machine which is at least equal to the vertical distance between said cutter bar and said cutter.

13. Agricultural machine according to claim 1, wherein at the top of said feed-through channel is provided a cutting element which allows to separate a seed-bearing end of said crop from the stalks.

14. Agricultural machine according to claim 1, wherein said cutter bar extends at least partly in front of said means of transport at said front.

15. Agricultural machine according to claim 1, wherein said cutter comprises a circular saw blade driven around a central axis thereof.

16. Method for harvesting a crop with stalks standing upright on a soil, wherein an elongated cutter bar having a cutting width is moved horizontally in a harvesting direction substantially perpendicular to the longitudinal direction of said cutter bar wherein, at the front of the cutter bar, said stalks are removed from the soil over said cutting width and the stalks are then moved upright to a feed-through channel which extends at least partly transversally with respect to the longitudinal direction of the cutter bar and within the cutting width of the latter, wherein the stalks are cut into at least two pieces while moving them upright through the feed-through channel,
characterised in that said stalks, as they move through the feed-through channel, are carried along by superimposed conveyor belts extending substantially in line with each other, wherein there is a free space between these superimposed, successive conveyor belts, and the stalks are cut into at least two pieces at the height of this free space by means of a cutter while the stalks are being moved upright through the feed-through channel, wherein after cutting the stalks into pieces, each piece is moved further along through the feed-through channel by at least one of the above-mentioned conveyor belts to an ejection opening where said pieces are ejected behind the cutter bar within the cutting width of the cutter bar.

17. Method according to claim 16, wherein said stalks, as they move through the feed-through channel, are clamped between opposite conveyor belts moving in the same direction which laterally delimit said feed-through channel, wherein these conveyor belts carry along said stalks through the feed-through channel.

18. Method according to claim 16, wherein said pieces of the stalks are ejected in one or several rows on the ground behind the cutter bar, so that these pieces extend substantially at right angles to said harvesting direction in said rows.

19. Method according to claim 16, wherein said stalks, after having been removed from the ground, are moved substantially parallel to the cutter bar to said feed-through channel where the stalks are moved substantially at right angles to the cutter bar to the rear of the cutter bar and subsequently are moved substantially at right angles to the harvesting direction or substantially parallel to the cutter bar through the feed-through channel before the stalks are ejected.

20. Method according to claim 16, wherein said stalks are cut near the ground by means of said cutter bar so as to remove them from the ground.

21. Method according to claim 16, wherein the top of the stalks of said crop has a seed-bearing end and, as the stalks are being moved through the feed-through channel, this seed-bearing end is separated from the stalks.

22. Method for harvesting a crop with stalks standing upright on a soil, wherein an elongated cutter bar having a cutting width is moved horizontally in a harvesting direction substantially transversal to the longitudinal direction of said cutter bar wherein, at the front of the cutter bar, said stalks are removed from the soil over said cutting width and the stalks are then moved upright to a feed-through channel which extends at least partly transversally with respect to the longitudinal direction of the cutter bar and within the cutting width of the latter,
characterised in that said stalks while being moved upright through the feed-through channel, are carried along by conveyor belts, wherein the stalks are moved further through the feed-through channel to an ejection opening where said stalks are ejected behind the cutter bar in one or several rows on the ground so that these stalks extend substantially transverse to said harvesting direction in said rows.

23. Method according to claim 22, wherein said stalks, after having been removed from the ground, are moved substantially parallel to the cutter bar to said feed-through channel where the stalks are moved substantially at right angles to the cutter bar to the rear of the cutter bar and subsequently are moved substantially at right angles to the harvesting direction or substantially parallel to the cutter bar through the feed-through channel before the stalks are ejected.
